(19) United States
(12) Patent Application Publication
(10) Pub. No.: US 2016/0159563 A1
(43) Pub. Date: Jun. 9, 2016

(54) Capsule For Beverages And Respective Production Apparatus And Method

(71) Applicant: SARONG SOCIETA ' PER AZIONI, Reggiolo (Reggio Emilia) (IT)

(72) Inventors: Andrea BARTOLI, Reggio Emilia (IT); Davide CAPITINI, Reggio Emilia (IT); Alessandro GRILLENZONI, Campogalliano (Modena) (IT)

(21) Appl. No.: 14/907,722

(22) PCT Filed: Jul. 25, 2014
(86) PCT No.: PCT/IB2014/063422

§ 371 Date: Jan. 26, 2016

(30) Foreign Application Priority Data
Jul. 26, 2013 (IT) MO2013A000214

(51) Int. Cl. B65D 85/804; B65B 31/00; B65B 3/02; B65B 51/10; B29C 51/26; B29C 51/10

(52) U.S. Cl. CPC B65D 85/8043; B29C 51/268; B29C 51/10; B65B 3/022; B65B 51/10; B65B 31/00

(57) ABSTRACT

A capsule for beverages with a casing which includes a base wall and a side wall defining a cavity for combining an initial product and a fluid to obtain an end product, and an edge extending from the side wall. The capsule includes a covering element fixed to the edge to close the cavity hermetically, which is pierceable by an extracting element of a dispensing machine. The casing is made by forming a sheet of thermoformable plastics. The edge includes a sealing element with a protrusion facing the base wall that is obtainable by the sheet forming a further cavity suitable for containing a fluid. The covering element is fixed to also seal hermetically the further cavity to create a cushion that is deformable between the edge and the covering element that defines the sealing element arranged for sealingly engaging, when compressed, with an abutting element of a dispensing machine.

### FIELD OF THE INVENTION

The invention relates to capsules or containers for preparing products, for example beverages, in automatic dispensing machines. In particular, the invention relates to a sealed, single-serving and disposable capsule containing an initial product that is able to make an end product by interacting with pressurised fluid. The invention further relates to an apparatus and a method for making such a capsule.

### BACKGROUND OF THE INVENTION

Known capsules for use on dispensing machines are disposable and single-serving containers comprising an outer casing, made of plastics impermeable to liquids and gases and having a beaker or cup shape. The casing has a bottom wall and a side wall defining an upper opening through which the product can be inserted from which to obtain the beverage. The upper opening is closed hermetically by a covering element, typically a sheet of aluminium of a film of plastics, so as to seal the product inside the container. The covering element is generally fixed to a flange-shaped edge of the casing, peripheral and annular edge, which is opposite the bottom wall and arranged around the upper opening. The capsule is pierceable to enable the pressurised liquid, typically water, to be delivered, and the obtained beverage to exit. In particular, the cover and the bottom wall of the casing are pierceable by suitable means of a dispensing machine to enable respectively the pressurised liquid to be delivered from above and the beverage to be extracted from below.

As illustrated schematically in FIG. 1, a dispensing machine 500 of known type comprises a housing 501 arranged for receiving and enclosing a capsule 550. A bottom portion of the housing 501 is provided with perforating elements 502 for perforating a bottom wall 551 of the capsule 550 and injecting the pressurised fluid or extracting the beverage therefrom. To prevent, during use, the fluid or the beverage escaping from the housing 501 because of the high operating pressure, a sealing member 503 has to be interposed between the capsule 550 and the housing 501.

The sealing member 503 generally comprises an annular washer, made of elastomeric material, interposed between a flange edge 552 of the capsule 550 and an abutting portion 505 of the housing 501. When the capsule 550 is closed in the housing 501, the sealing member 503 is compressed by a perforating element 504, thus ensuring the hydraulic seal.

One drawback of this solution lies in the fact that the washer, after being subjected to wear and deterioration with use, comes into contact with the product and/or fluid each time a beverage is dispensed without being able to be properly washed subsequently. From a hygienic point of view this solution is not optimum.

In order to overcome this drawback, capsules are known that include a sealing element made of yieldable, typically elastomeric, material, which, when it is crushed when the capsule is inserted into the dispensing machine, ensures the seal. Such seals can also be used in dispensing machines devoid of sealing members.

Patent EP 1654966 illustrates a capsule for beverages comprising an elastic sealing element fixed to a circumferal edge of the capsule made of elastomeric material, in particular silicone rubber, different from the material used to form the capsule. The elastic element can be fixed to the casing of the capsule at a peripheral edge or a bottom wall of said casing.

A capsule or this type is nevertheless very expensive because it requires the connection to the casing of the capsule of the sealing element in silicone rubber to be made and connected, which is, however, difficult to fix by heat-sealing.

Capsules are also known from patent EP2303077 or from application EP2389326 which comprise a sealing element made of the same material as the casing of the capsule. The sealing element is in this case made as a plurality of concentric circumferal ridges made in the edge of the capsule, which nevertheless require great manufacturing precision by means of injection moulding to ensure an optimum seal when the capsule is inserted into the dispensing machine.

If this precision is not achieved, undesired leaks can occur when pressurised fluid is injected into the capsule and/or fills the housing into which the capsule is inserted.

### SUMMARY OF THE INVENTION

One object of the present invention is to improve known capsules for beverages, in particular capsules usable in known dispensing machines provided with a housing suitable for containing and sealingly enclosing a capsule.

Another object is to make a capsule that is usable in known dispensing machines that ensures the seal during dispensing without the need for a specific sealing member of the housing.

A further object is to obtain a capsule that is cheap and easy to use.

Yet another object is to provide an apparatus for making the capsule having simple and reliable operation and a highly productive manufacturing method.

According to a first aspect of the invention a capsule is provided for beverages according to claim 1 and one or more claims appended thereto.

According to a second aspect of the invention an apparatus is provided for making capsules according to claim 14 and one or more claims appended thereto.

According to a third aspect of the invention a method is provided for making capsules according to claim 23 and one or more claims appended thereto.

### BRIEF DESCRIPTION OF THE DRAWINGS

The invention can be better understood and implemented with reference to the attached drawings that illustrate some embodiments thereof by way of non-limiting example, wherein:

FIG. 1 is a schematic cross section of a known capsule for beverages associated with a dispensing machine which is also of known type;

FIG. 2 is a schematic cross section of a capsule according to the invention associated with a dispensing machine, illustrated schematically;

FIG. 3 is a partial frontal view, with some illustrated parts sectioned for clarity, of a capsule according to the invention;

FIG. 4 is an enlarged partial schematic cross section of an edge of the capsule of FIG. 3;

FIG. 5 is an enlarged partial schematic cross section of an edge of an alternative embodiment of the capsule of FIG. 3;

FIG. 6 is a frontal schematic view of a forming arrangement of the forming apparatus of the invention during a preliminary forming step, in which a first operating device and a second operating device are in a forming position for shaping a sheet material and a punch that is part of the second operating device is in an inactive raised position that is not in contact with the sheet material;

FIG. 7 is a frontal schematic view of the forming apparatus of FIG. 5 in an initial operative forming step, wherein the punch is in a lowered work position and cooperates with a seat of the first operating device.

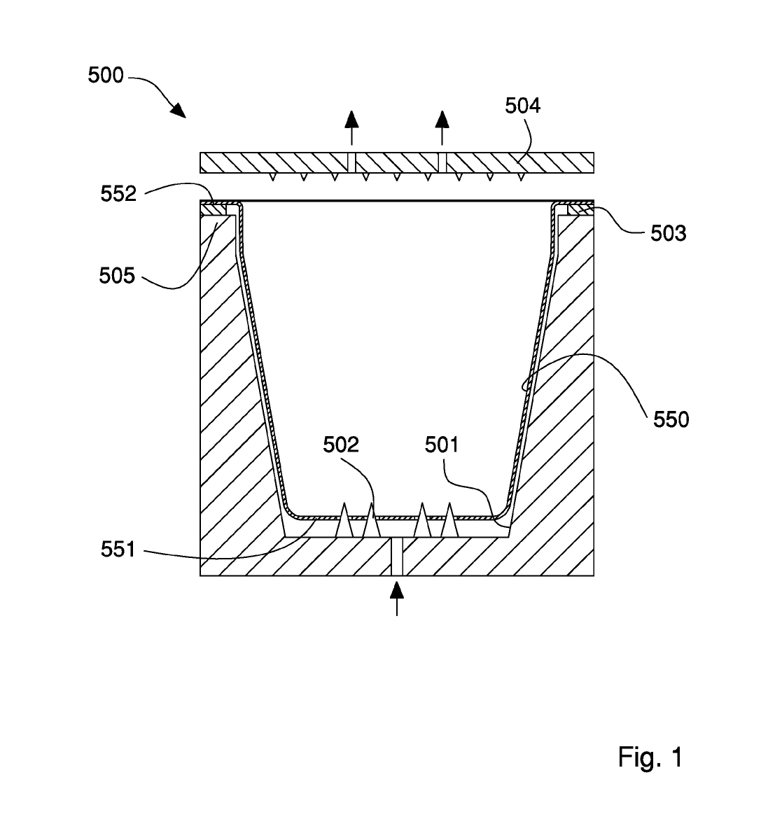

### DETAILED DESCRIPTION OF THE INVENTION

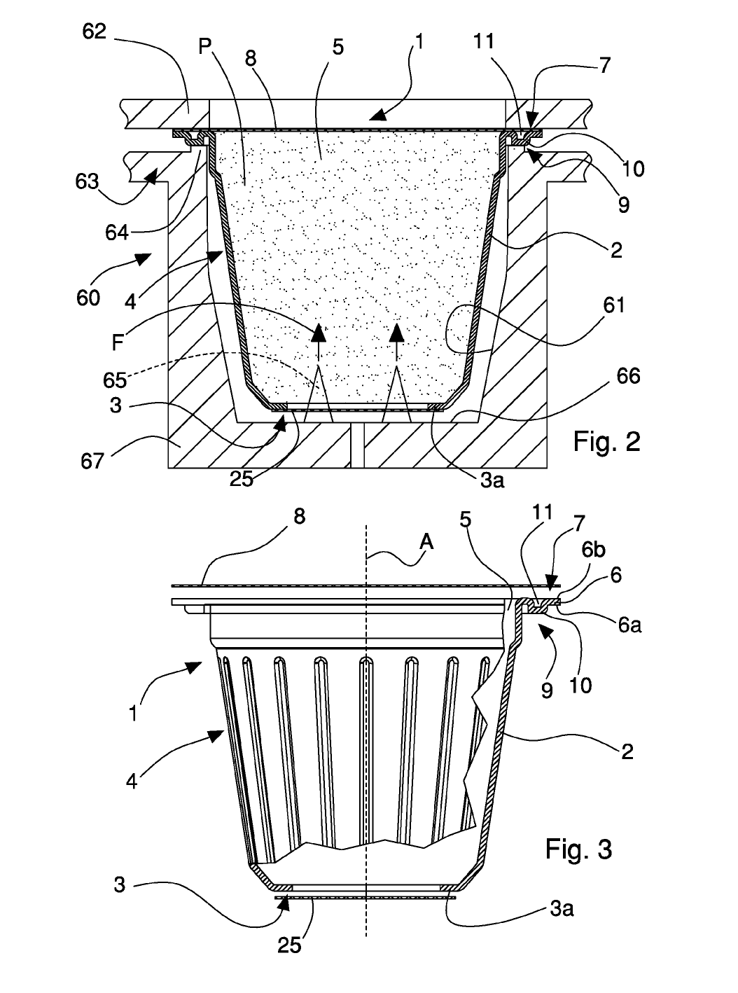

With reference to FIG. 2 a capsule 1 is illustrated for beverages according to the invention, which is usable in a dispensing machine 60, which is disclosed below, for producing an end product, in particular a hot beverage, for example coffee, barley, herbal tea, tea, chocolate, etc, by injection of a hot pressurised fluid F into the interior thereof.

The capsule 1 of the invention comprises an outer casing or container 2, in turn comprising a base wall 3 and a side wall 4 defining a cavity 5 that is open and suitable for containing an initial product P, for example a soluble or percolable food product to be combined with a fluid, typically water, to obtain an end product. The base wall 3 and the side wall 4 define a substantially beaker or cup-shaped body of the capsule 1.

The casing further comprises a flange-shaped edge 7 connected to the side wall 4 and extending therefrom, arranged around the opening of the cavity 5. The edge 7 is further opposite the base wall 3 and faces outwards with respect to the cavity 5.

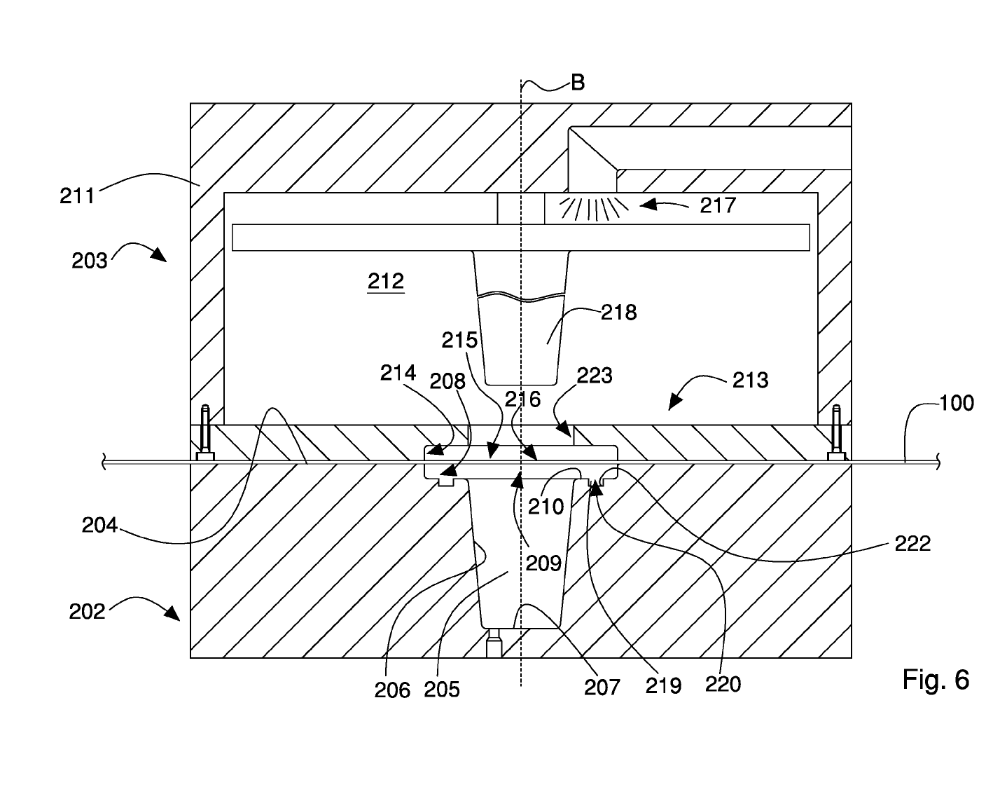

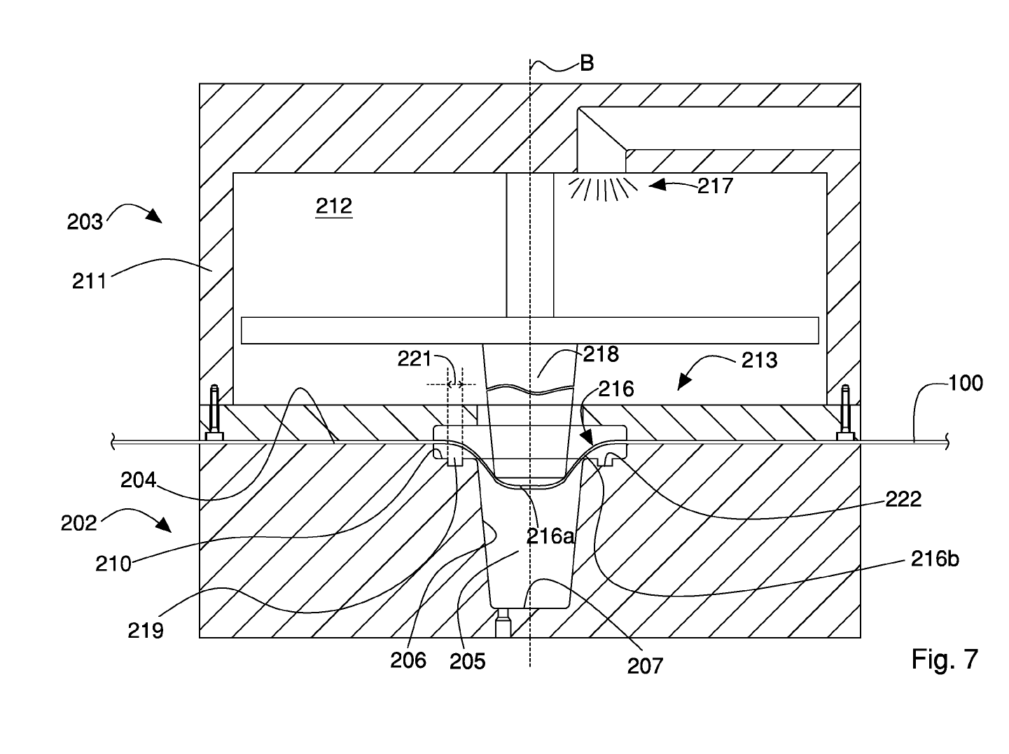

The casing 2 is made by forming a sheet of thermoformable plastics 100 (FIG. 6 and FIG. 7) that is suitable for the process of preparing the end product starting with the initial product P, which is for example able to withstand without deformation temperatures up to 100° C. and pressure up to 5 bar.

This sheet of plastics 100 can have a thickness comprised between 15 micron and 1200 micron, in particular between 15 micron and 700 micron and is made of a polyolefin, for example polypropylene PP and/or polyethylene PE and/or polyamide PA.

In detail, the sheet material can comprise one first layer of material, in particular suitably for contacting and/or conserving the initial product P, for example made of polypropylene PP that is impermeable to humidity, a second layer of material that is not in contact with the initial product P made of material that is impermeable to gas, in particular to oxygen and optionally also to humidity, also known as a barrier layer, and a third layer of outer material.

The barrier layer, interposed between the first and the second layer, ensures complete insulation from the external environment of the cavity 5, in particular if the first layer is permeable over time to oxygen. The barrier layer has a thickness comprised between 2 micron and 100 micron, in particular between 15 micron and 70 micron, and is made for example of ethylene vinyl alcohol (EVOH), which is gas impermeable only to oxygen, or polyvinylidene chloride (PVDC), which is gas impermeable both to oxygen and humidity. According to a first embodiment (not shown) of the sheet material, the first and the third layer are made of the same material, for example polypropylene PP and are coupled with the barrier layer interposed therebetween. Such layers can have the same thickness (for example 350 micron), or different thicknesses (for example the first layer can have a thickness of 500 micron whereas the third layer can have a thickness of 300 micron).

According to a second alternative embodiment (not shown), the first layer is a supporting layer and is made of polypropylene PP, the second layer is the barrier layer (EVOH or PVDC) and the third layer is an extruded layer of polypropylene PP or polyethylene PE, of a thickness equal to 15 micron, which is coupled with the first and the second layer during the process of manufacturing the sheet material.

The sheet material, both according to the first and to the second embodiment, is thus selected in such a manner as to protect over time the initial product P contained in the capsule from humidity and from oxygen.

The capsule further comprises a covering element 8 fixed to the edge 7 of the casing 2 to seal hermetically the capsule 1, i.e. the open cavity 5 and thus conserve the product P. The covering element 8 comprises a sheet of aluminium or a film of plastics provided with a barrier layer that is pierceable by an extracting element for extracting the end product of the dispensing machine 60.

The covering element 8 is fixed to the edge 7 of the casing 2 by thermal or ultrasound welding, or gluing. The covering element 8 is fixed to the casing by heat-sealing, as will be seen better below.

The base wall 3 of the capsule has further a circular hole bound by a further annular edge 3a extending up to the side wall 4 of the capsule. A further covering element 25, similar to the covering element 8 and pierceable by a cutting device and/or an injection device of the fluid F of the dispensing machine 60, is fixed to the further edge 3a outside the base wall 3, to close the hole thereof, similarly to what has already been said for the covering element 8.

The thickness of the covering element 8 and/or of the further covering element 25 is expressed in grams and is comprised between 80 and 90 g/square metre.

The edge 7 of the capsule comprises a sealing element 9 that comprises at least one protrusion 10 that is also obtainable by thermoforming that faces the base wall and defines at least one further open cavity 11 that is suitable for containing a fluid, for example air or inert gas.

The covering element 8 is fixed to the edge 7 of the casing 2 to hermetically seal also the further cavity 11, so as to create a cushion that is deformable between the edge 7 and the covering element 8 that defines the sealing element 9.

In addition to the protrusion 10, the edge 7 also has an annular flat end 6.

As illustrated in FIG. 2, the dispensing machine 60, which is of known type and is not disclosed in detail, comprises a seat or space 61 that is suitable for receiving and containing the capsule 1 and a locking member 62 arranged for locking firmly to the inside of the aforesaid space 61 the capsule 1, in an operating configuration.

The dispensing machine 60 further comprises cutting members 65 placed on the bottom 66 of the space 61 and arranged for perforating the base wall 3 of the capsule, in particular the further covering element 25. An injection device of the fluid F (not shown) is suitable for supplying the pressurised fluid F to the seat 61 of the dispensing machine 60. This fluid F is in turn injected inside the cavity 5 of the capsule through the openings made on the base 3 of the capsule by the cutting members 65.

An extracting element (not illustrated) is provided for perforating the covering element 8 so as to enable the end product to exit the capsule 1.

In one condition of use, the flange-shaped edge 7 of the capsule 1 is clamped and compressed between the locking member 62 and a portion 63 of a supporting frame 67 of the dispensing machine 60 in which the space 61 is obtained.

The locking member 62 comprises, for example, an annular plate that acts on the edge 7 of the casing 2.

An abutting element 64 is provided on the supporting portion 63 of the frame 67 and comprises one or more annular ridges that abut on the sealing element 9 of the capsule 1. As the sealing element 9 is a deformable cushion filled with a fluid, for example, air or inert gas, because of the pressure of contact generated by the locking member 62 in the operating configuration, it deforms locally and substantially takes on the shape of the annular ridges of the abutting element 64.

In this manner the sealing element 9 is able to engage sealingly, when compressed, with the abutting element 64 of the dispensing machine 60.

This deformation ensures an optimal seal of the edge 7 with the supporting portion 63 of the frame 67, which prevents leaks therefrom of pressurised fluid F or end product during a dispensing operating step.

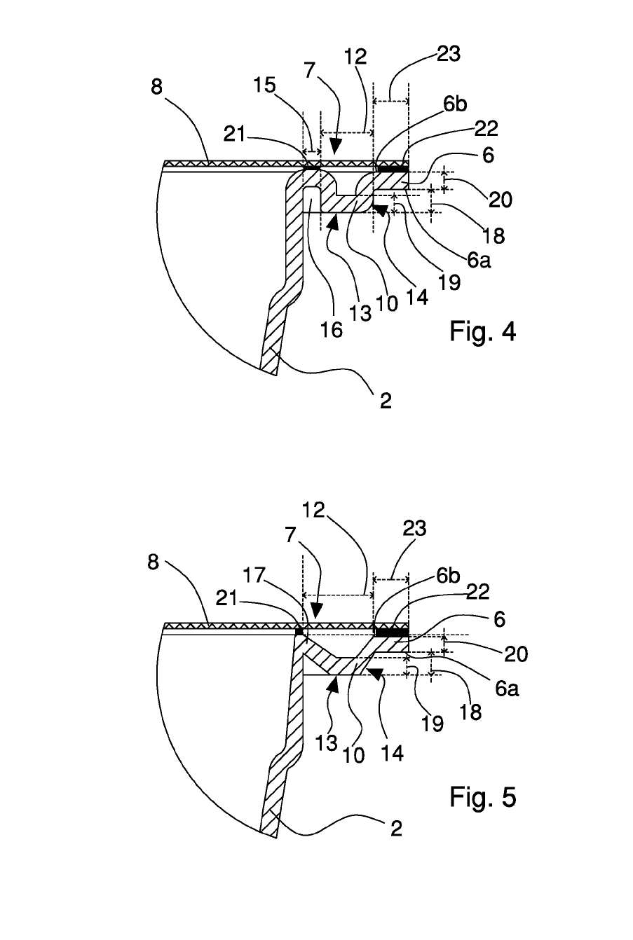

The protrusion 10 that is obtainable by thermoforming is arranged in a first annular circumferal zone 12 (FIG. 4) of the edge 7. The protrusion 10 is also beaker or cup-shaped and comprises a respective base wall 13, parallel to the base wall 3 of the capsule 1, and a side wall 14 defining the further open cavity 11.

The first annular zone 12 is created by the overall dimensions of the protrusion 10 into the edge 7 in a radial direction with respect to an axis of symmetry A of the capsule 1, and i.e. as a maximum radial extent of the opening of the further cavity 11.

The sealing element 9 can comprise a single continuous annular protrusion 10 arranged in the first annular zone 12 and in this case the further cavity 11 is annular, circumferal and continuous arranged outside the cavity 5 in a radial direction with respect to the axis of symmetry A.

According to an alternative embodiment not shown, the sealing element 9 comprises a plurality of protrusions 10 arranged in separate portions of the first annular zone 12, which define a plurality of further cavities 11 which are separate and arranged circumferally in the first annular zone 12.

According to a different alternative embodiment (not shown), the plurality of protrusions 10 are arranged alternatively in separate portions of first annular zone 12 and of a second annular circumferal zone (not shown) of the edge 7, arranged externally the first annular zone 12 in a radial direction with respect to the axis of symmetry A.

The radial extent, i.e. the extent measured in a radial direction, of the first annular zone 12 is selected in such a manner as to enable the capsule 1 to adapt to different models of dispensing machine, abutting on the abutting element 64 of the dispensing machine 60 however they are arranged radially in the dispensing machine 60. It is observed that if optionally both the first annular zone 12 and the second annular zone are present because the protrusions 10 are arranged in distinct concentric annular zones, the radial extent measurements that will be provided below are to be deemed to be without loss of scope for a radial extent that includes both the first annular zone 12 and the second annular zone.

As shown in FIG. 4, the first annular zone 12 has a radial extent comprised in a range from 1.50 mm to 2.8 mm, in particular in a range comprised between 1.60 mm and 2.50 mm, in particular equal to 1.67 mm.

The first annular zone 12 further has a distance 15 from the side wall 3, measured from the side wall 4 of the capsule 1 to the first annular zone 12 that is less than 1.20 mm, in particular 0.75 mm.

It should be noted that in the capsule 1 shown in FIG. 4 the distance 15 is not nil because there is a substantially annular space 16 interposed between the side wall 4 of the capsule and the side wall 14 of the protrusion 10 that spaces the protrusion 10 apart from the side wall 4 of the capsule 1.

According to an alternative embodiment of the capsule shown in FIG. 5, the annular space 16 is absent and the distance between the protrusion 10 and the side wall 4 of the capsule 1 is substantially nil inasmuch as the side wall 4 of the capsule and the side wall 14 of the protrusion 10 have a common origin and define together an acute vertex 17 angle.

Also the dimensions of the annular flat end 6 contribute to making the sealing element, as will be seen below. The annular flat end 6 has a radial extent 23 comprised between 1.2 mm and 1.5 mm, in particular 1.42 mm.

Considering on the other hand a measurement along an axis parallel to the axis of symmetry A, the protrusion 10 has a longitudinal extent 18 and thus a height, from a surface 6a of the annular flat end 6 facing the base wall 3 of the capsule 1 to the base wall 13 of the protrusion 10, comprised between 0.6 mm and 0.80 mm. If the base wall 13 of the protrusion 10 is parallel to the base wall 3 of the capsule 1, the longitudinal extent 18 is constant and may be equal to 0.75 mm.

Nevertheless, the protrusion 10 can have a total longitudinal extent that is greater than the longitudinal extent 18, summed to the thickness of the casing 2, if the thermoforming is deeper in certain edge portions 7 than the annular flat end 6 thereof, as, for example, in FIG. 5 in which the vertex 17 of the capsule is not aligned on a surface 6b of the annular flat end 6 of the edge 7, opposite the surface 6a.

If a thickness of the casing 2 in the edge 7 is now considered, it has been established experimentally that deformation of the sealing element is effective if in the edge 7 the casing has a thickness comprised in a range from 0.10 mm to 0.60 mm, and in particular if in the protrusion 10 the casing 2 has a first thickness 19 comprised in a range from 0.10 mm to 0.60 mm, in particular comprised in a range from 0.15 to 0.55 mm, in particular comprised in a range from 0.15 mm to 0.40 mm, in particular comprised in a range from 0.15 a 0.20 mm; if on the other hand the annular flat end 6 has a second thickness 20 comprised in a range from 0.10 mm to 0.60 mm, in particular in a range from 0.15 mm to 0.55 mm, in particular in a range from 0.15 mm to 0.40 mm, in particular in a range from 0.20 mm to 0.25 mm.

The first thickness 19 and the second thickness 20 are suitably selected inasmuch as they have to enable the sealing element 9 to flex and deform when compressed by the abutting element 64 of the dispensing machine 60.

The covering element 8 is joined to the edge 7 of the capsule 1, in particular by heat-sealing, at least along a first 21 and a second 22 annular joining portion respectively inside and outside the first annular zone 12 in a radial direction.

The first joining portion 21 has a radial extent comprised between 0.3 mm and 0.6 mm, in particular equal to 0.4 mm.

The second joining portion 22 has a radial extent comprised between 1 mm and 1.8 mm, in particular 1.42 mm, and extends substantially along the entire flat end 6. If the capsule 1 comprises protrusions 10 arranged alternatively in separate portions of the first annular zone 12 and of the second annular circumferal zone of the edge 7, beyond the first joining portion 21 and the second joining portion 22 there is a third joining portion, respectively outside the second annular zone in a radial direction and the covering element 8 is joined to the edge 7 of the capsule 1, in particular by heat-sealing, also along the third joining portion.

In this case, the first joining portion 21 and the second joining portion 22 have a radial extent comprised between 0.3 mm and 0.6 mm, in particular equal to 0.4 mm, whereas the third joining portion has a radial extent comprised between 1 mm and 1.8 mm, in particular 1.42 mm inasmuch as it extends over the entire annular flat end 6.

The first joining portion 21 and the second joining portion 22 and optionally the third joining portion, above all when obtained by heat-sealing, have blocking features in the sense that they ensure that the capsule maintains over time the initial product P in ideal conditions during storage but at the same time ensure that the sealing element 9 is maintained unaltered even when the latter flexes and is deformed by the abutting element 64 of the dispensing machine 60. In other words, the joining portions do not yield and maintain the sealing element 8 whole and joined to the casing 2 even when the joining portions are subjected to pressure.

The capsule 1 of the invention thus ensures an optimum seal inside the dispensing machine, during the dispensing step without requiring the use of specific washers associated with the dispensing machine and/or with the capsule.

In this manner optimum hygienic conditions are ensured in the dispensing procedure and moderate capsule production costs, as the capsule can be rapidly and easily obtained by thermoforming of a sheet of plastics. Owing to the presence of the deformable cushion between the edge 7 and the covering element 8 that defines the sealing element 9, the capsule can adapt to different embodiments of the abutting element 64 of the dispensing machines 60, without the need to make different shaped edges 7 for each type of model of dispensing machine.

The capsule 1 of the invention is thus able to adapt to different models of dispensing machine 60.

It is added that the deformability of the sealing element 9 is ensured by the type of selected sheet material, which is per se deformable, but above all by the thickness of the casing 2 in the edge 7 of the capsule 1, which is obtainable by thermoforming.

In particular, the thickness 19 of the thermoformed casing 2 in the protrusion 10 ensures the deformability of the air cushion and the flexibility thereof and ensures the efficacy of the protrusion 10 as a sealing element 9. Further, in experiments it has been observed that also selecting a suitable thickness 20 in the annular flat end 6 and the radial extent 23 is important because also the annular flat end 6 contributes to making an effective seal.

The annular flat end 6 of the edge 7 is in fact able to become deformed and follow the contour of the abutting element of the dispensing machine over the entire radial extent 23, contributing to preventing undesired losses of liquid.

The simplicity of manufacture of the capsule by thermoforming and the placing of the joined covering element 8 in the first and in the second joining portion 21 and 22 on opposite sides of the protrusion 10 thus ensures that a deformable cushion is made in a simple manner, reducing production costs significantly.

The forming apparatus for making the capsule 1 by forming a thermoformable sheet material 100 comprises a forming arrangement of a casing 2 of the capsule shown in FIGS. 6 and 7, which is associated with a forming station (not shown).

The casing 2 comprises a base wall 3, a side wall 4 defining with the base wall 3 a cavity 5 and an edge 7 extending from the side wall 4.

The apparatus can further comprise a plurality of workstations (not shown) arranged upstream or downstream of the forming station, like for example a heating station for heating the sheet material 100 arranged upstream of the forming station to bring the sheet material 100 to high temperatures so as to enable the sheet material 100 to be softened and deformed plastically in the subsequent forming station. Downstream of the forming station there is further a cutting station where a suitable cutting device punches in each casing 2 a hole in a base wall 3 of the capsule, bounded by a further annular edge 3a. A first joining station is provided for joining, in particular by heat-sealing, a covering element 25 to the edge 3a of the base wall 3 with an outer closure of the hole obtained therein. The cutting device further separates the thermoformed casings 2 from the sheet of material 100 from which they have been obtained, and the first joining station can be provided upstream or downstream of the cutting station, to close the base wall 3 of the capsule with thermoformed casings 2 that have already been separated or are still joined to the sheet material 100.

A filling station for filling the cavity 5 of the casing 2 with the product P can be provided upstream or downstream of the cutting station, in the sense that thermoformed casings 2 can be filled (in which clearly the further covering element 25 has already been joined to the base wall 3 to close the hole obtained therein) but still joined to the sheet material 100 or casings 2 can be filled that are cut individually and separated from one another, for example because filling is not performed in line with respect to the forming. A second joining station is further provided for joining, in particular by heat-sealing, a covering element 8 to an edge 7 of the casing 2 at a first joining portion 21, at a second joining portion 22 and optionally at a third joining portion.

The forming arrangement of the casing 2 comprises a first operating device 202 and a second operating device 203, respectively positioned on opposite sides, for example below and above the sheet material 100 supplied thereto, which are movable along a forming axis between a spaced apart position (not shown) in which the sheet material 100 can be supplied thereto and a forming position, shown in FIGS. 6 and 7, in which the sheet material 100 is shaped to define the casing 2 of the capsule.

In a known manner, the first operating device 202 is provided with a supporting surface 204 that is substantially flat and configured for supporting, during forming, the sheet material and is provided with a seat 205 provided with side walls 206 and with a bottom wall 207 that are respectively suitable for shaping the base wall 3 and the side wall 4 of the casing 2. The seat 205 is substantially cup-shaped to shape a body of the capsule.

The first operating device 202 further comprises a space 208 communicating with a mouth 209 of the seat 205 and having, in a plan view, greater overall dimensions than the seat 205. The space 208 comprises an abutment wall 210 surrounding the seat 205 which is substantially parallel to and spaced apart from the supporting surface 204. The reason for which the abutment wall 210 is spaced apart from the supporting surface 204 is illustrated below in greater detail.

The first operating device 202 is further provided with conduits (not shown) within which a cooling fluid flows that is suitable for rapidly cooling the sheet material when the latter is deformed in a final forming step inside the seat 205 obtained in the first operating device 202, so as to confer appropriate stiffness features on the body of the capsule 1 after thermoforming.

The second operating device 203 comprises in a known manner a bell 211 bounding a closed space 212 within which the casing of the capsule 1 is formed, when the first operating device 202 and the second operating device 203 are in the forming position.

The second operating device 203 further comprises a punch 218 that is movable inside the bell 211 between a raised position in which it is inactive and not in contact with the sheet material (FIG. 6) in a preliminary forming step and a lowered work position in which the punch cooperates with the seat 205, intercepting the sheet material 100 to push the sheet material 100 toward the seat 205 (FIG. 7) during at least a first forming operating step.

In the second operating device 203 a plate 213 is also provided to lock the sheet material against the supporting surface 204 during forming of the capsule 1 and a further space 214 is also provided suitable for defining with the space 208 a chamber 215 bounding a portion 216 to be formed of the sheet material, intercepted by the punch 218 in the first forming step.

The second operating device 203 further comprises compressed air supplier 217 for supplying compressed air to the chamber 215 to press the sheet material 100 in a final forming step (not shown) against the bottom wall 207 and the side wall 206 of the seat 205 and against the abutment wall 210, thus shaping the base wall 3, the side wall 4 and the edge 7 of the casing 2 of the capsule.

To enable this, the plate 213 is provided with a hole 223 to permit the passage of the punch 218 and of the compressed air into the chamber 215 and towards the first operating device 202.

The first operating device 202 comprises according to the invention at least a further seat 219 also communicating with the space 208 by a respective mouth 220.

The further seat 219 is arranged outwardly the seat 205 in a radial direction with respect to the forming axis B and is suitable for shaping the further cavity 11 in the edge 7 of the casing 2 via the compressed air supplied to the chamber 215 in the final forming step, making the corresponding protrusion 10.

The further seat 219 is obtained in a first annular circumferal section 221 of the abutment wall 210, in a radial direction with respect to the forming axis B, which corresponds in the formed capsule 1 to the first annular circumferal zone 12 of the edge 7, in which the protrusion 10 is arranged. The first annular circumferal section 221 is suitable for shaping in the casing 2 the first annular circumferal zone 12 of the edge 7.

The further seat 219 comprises a respective bottom wall 222, substantially parallel to the bottom wall 207 of the seat 205.

If the further seat 219 is a continuous annular groove arranged in the first annular section 221, the protrusion 10 of the casing 2 and thus of the finished capsule obtainable by the forming arrangement 201 is also one continuous annular protrusion.

If on the other hand the first operating device 202 comprises a plurality of grooves (not shown) arranged in separate portions of the first annular section 221, the capsule 1 obtainable by the forming arrangement 202 and 203 will comprise a plurality of separate protrusions 10.

According to an alternative embodiment of the present invention (not shown), the first operating device 202 can comprise a plurality of grooves arranged alternatively in separate portions of the first annular section 221 and of a second annular section, arranged externally in a radial direction with respect to the first annular section 221 to obtain a casing 2, and thus a capsule, provided with protrusions arranged alternatively along the first annular zone 12 and the second annular zone.

As mentioned previously, the forming apparatus further comprises a cutting device for cutting the sheet material after forming, thus obtaining formed casings 2 provided with the edge 7 and with the cup body, made by the base wall 3 and the side wall 4. The cutting device is arranged for cutting the sheet material outside the first annular section 221, at a distance from the first annular section that is such as to make in the finished capsule the annular flat end 6 of the desired dimension.

The forming apparatus further comprises a joining device arranged for joining, by heat-sealing, the covering element 8 to the thermoformed casing 2, at a first and at a second joining portion of the joining device (not shown) to obtain a finished capsule provided with a casing 2 joined to the covering element 8 at a first 21 and at a second 22 annular joining portion.

In this manner, the covering element 8 can close hermetically both the cavity 5 and the further cavity 11 and as air is trapped a deformable cushion is made that defines the sealing element 9, which is arranged for being deformed and sealingly engaging, when compressed, with the abutting element 64 of a dispensing machine. Alternatively, and without limiting scope, a fluid other than air such as an inert gas such as nitrogen instead of air can be supplied in a known manner to ensure the wholeness of the product P contained in the capsules.

In order to make the capsule 1 of the invention by means of the apparatus disclosed above, a method is provided for forming a casing 2 of the capsule that comprises in a preliminary forming step arranging in contact in a forming position first operating device 202 and second operating device 203 that are moveable towards and away from one another along a forming axis B and arranging a punch 218 of the second operating device in a raised position in which it is inactive.

The method further provides for supporting a sheet material and shaping a base wall 3 and a side wall 4 of the casing 2 of the capsule by a seat 205 obtained in a first operating device 202, providing a space 208 communicating with a mouth 209 of the seat 205 having, in a plan view, greater overall dimensions than the seat 205.

The method further comprises defining a chamber 215 between the space 208 and a further space 214 of a second operating device 203 to bound a portion to be formed 216 of the sheet material 100 and locking the material at least in a first forming step in which a punch 218 of the second operating device 203 intercepts the portion to be formed 216, pushing the portion towards the seat 205.

In the first forming step, the punch 218 is in fact lowered that intercepts a central portion 216a of the portion to be formed 216, pushing the central portion 216a against the seat 205 as shown in FIG. 7.

It should be noted that the portion to be formed 216 has side portions 216b suspended inside the chamber 215, from the central portion 216a up to a locking point by a plate 213, inasmuch as the abutment wall 210 is spaced apart from the supporting surface 204 in which the sheet material is supported and advanced. The seat 205 and the further seat 219 are in other words lower than the supporting surface 204, considering a vertical forming axis B. Such suspended side portions 216b enable the material to maintain an optimum thermoforming temperature to avoid undesired cooling in contact with the cooled walls of the seat 205, before the moment in which the sheet material has to be shaped into the definitive shape of the casing 2.

Further, the sheet material 100 is in this manner stretched more vertically and this avoids undesired accumulations of plastics, especially at the locking points.

After the punch 218 in the lowered position has intercepted the sheet material, compressed air is supplied to the chamber 215 in a final forming step, to press the sheet material against the seat 205 and against the abutment wall 210 of the space 208 that surrounds the seat 205, thus forming an edge 7 of the casing 2 extending from the side wall 4. As the further seat 219 is also in communication with the space 209 and is arranged outside the seat in a radial direction, also the further cavityl 1 is formed in the edge 7 of the casing 2 at the same time as the cavity 5 inasmuch as the sheet material in the final forming step is pressed by the compressed air also against the bottom wall 222 and the side walls of the further seat 219.

It should thus be noted that the forming of the casing 2 is terminated owing to the compressed air supplied in the final forming step.

Owing to the suspended side portions 216b, the presence is avoided of zones of the sheet material at a lower temperature than the ideal forming temperature and thus the casing 2, when it is pressed and stabilised by the compressed air against the cooled surfaces of the first operating device 202, takes on a defined and precise final shape without zones of incorrectly shaped material.

After forming, in particular thermoforming, the base wall 3 of the casing is cut and then joined to the further covering element 25 to enable subsequent filling of the cavity 5.

Once the cavity 5 is filled with a dose of initial product P, the casing 2 is closed hermetically by heat-sealing fixing a covering element 8 to an edge 7 of the casing 2, and making the cavity 5 containing the initial product P and the further cavity 11 containing a fluid, air or inert gas.

Owing to the apparatus and to the method of this invention, a sealing element 9 is made simply and cheaply by thermoforming, forming simultaneously a cavity 5 and a further cavity 11 of the edge 7 of the casing 2 by means of the seat 205 and the further seat 219. By further joining the hermetically sealed covering element 8 of the cavity 5 and of the further cavity 11 and simply letting air into the further cavity 11 or supplying a different pressurised fluid thereto as an inert gas, a deformable cushion is made defining the sealing element 9 of the capsule arranged for being deformed and sealingly engaging, when compressed, with an abutting element 64 of a dispensing machine.

1. A capsule for beverages comprising a casing in turn comprising a base wall and a side wall defining a cavity suitable for containing an initial product to be combined with a fluid to obtain an end product, and further comprising an edge extending from said side wall; wherein said capsule further comprises a covering element fixed to said edge to seal hermetically said cavity, said covering element being pierceable by an extracting element of a dispensing machine wherein said capsule is usable, wherein said casing is made by forming a sheet of thermoformable plastics and that said edge comprises a sealing element comprising at least one protrusion facing said base wall which is also obtainable by said forming, said protrusion defining at least one further cavity suitable for containing a fluid, for example air or inert gas, said covering element being fixed to seal hermetically also said further cavity so as to create a cushion that is deformable between said edge and said covering element that defines said sealing element arranged for sealingly engaging, when compressed, with an abutting element of a dispensing machine.

2. The Capsule according to claim 1, wherein said protrusion is arranged in a first annular circumferal zone of said edge.

3. The Capsule according to claim 2, wherein said sealing element comprises a single continuous annular protrusion arranged in said first annular zone.

4. The Capsule according to claim 2, wherein said sealing element comprises a plurality of protrusions arranged in separate portions of said first annular zone.

5. The Capsule according to claim 4, wherein said plurality of protrusions are arranged alternatively in separate portions of said first annular circumferal zone and of a second annular circumferal zone of said edge, arranged externally in a direction that is radial to said first annular zone.

6. The Capsule according to claim 2, wherein said first annular zone has a radial extent comprised in a range from 1.50 mm to 2.8 mm, in particular in a range comprised between 1.60 mm and 2.50 mm, in particular equal to 1.67 mm.

7. The Capsule according to claim 2, wherein said first annular zone has a distance from said side wall that is less than 1.20 mm, in particular 0.75 mm.

8. The Capsule accord ing to claim 1, wherein said protrusion has a longitudinal extent comprised between 0.6 mm and 0.80 mm, said longitudinal extent being measured along an axis parallel to a symmetry axis of the capsule from a surface of an annular flat end of said edge facing said base wall of said capsule to a base wall of said protrusion; and wherein in particular said longitudinal extent is constant and equal to 0.75 mm, if said base wall of said protrusion is parallel to said base wall of said capsule.

9. The Capsule according to claim 1, wherein in said edge the casing has a thickness comprised in a range from 0.10 mm to 0.60 mm, and in particular in the protrusion the casing has a first thickness comprised in a range from 0.10 mm to 0.60 mm, in particular comprised in a range from 0.15 to 0.55 mm, in particular comprised in a range from 0.15 mm to 0.40 mm, in particular comprised in a range from 0.15 and 0.20 mm; and wherein in the annular flat end the casing has a second thickness comprised in a range from 0.10 mm to 0.60 mm, in particular in a range from 0.15 mm to 0.55 mm, in particular in a range from 0.15 mm to 0.40 mm, in particular comprised in a range from 0.20 mm to 0.25 mm, said first thickness and said second thickness being such as to enable said sealing element to flex and be deformed, when compressed, by said abutting element of said dispensing machine.

10. The Capsule according to claim 1, wherein said edge has an annular flat end, the radial extent of which is comprised between 1.2 mm and 1.5 mm, in particular 1.42 mm.

11. The Capsule according to claim 1, wherein said covering element is joined to said edge of said capsule, in particular by heat-sealing, along a first annular joining portion and a second annular joining portion respectively inside and outside said first annular zone in a radial direction.

12. The Capsule according to claim 11, wherein said protrusion is arranged in a first annular circumeral zone of said edge; wherein said sealing element comprise a plurality of protrusions arranged in seperate portions of said first annular zone: wherein said plurality of protrusions are arranged alternatively in seperate portions of said first annular circumferal zone and of a second annular circumferal zone of said edge, arranged externally in a direction that is radial to said first annular zone; and comprising a third joining portion, respectively outside said second annular zone in said radial direction, said covering element being joined to said edge of said capsule, in particular by heat-sealing, also along said third joining portion.

13. The Capsule according to claim 1, wherein said sheet of thermoformable plastics comprises at least one first layer of material, in particular contacting and/or conserving said initial product and a second layer of material, made of material that is impermeable, in particular to oxygen.

14. A forming aapparatus for making a capsule by forming a sheet of thermoformable plastics, wherein said capsule comprises a casing, in turn comprising a base wall and a side wall defining a cavity and an edge extending from said side wall, said apparatus comprising a forming arrangement of said casing comprising: a first operating device provided with a supporting surface of said sheet material, with a seat that is suitable for shaping said base wall and said side wall of said casing and with a space communicating with a mouth of said seat and having, in a plan view, greater overall dimensions than said seat; a second operating device comprising a plate comprising a further space suitable for defining with said space a chamber bounding a portion to be formed of said sheet material, a punch cooperating with said seat and suitable for intercepting said portion during at least a first forming operating step, wherein said plate is suitable for locking said sheet material against said supporting surface, wherein said second operating device comprises a compressed air supplier for supplying compressed air to said chamber to press said sheet material in a final step of said forming against said seat and against an abutment of said space surrounding said seat so as to shape said base wall, said side wall and said edge of said casing; and wherein said first operating device and said second operating device are movable between a spaced apart position and a forming position along a forming axis, wherein said first operating device further comprises at least one further seat communicating with said space by a respective mouth, said further seat being arranged outwardly said seat in a radial direction with respect to a said forming axis and being suitable for shaping a further cavity in said edge of said casing by said compressed air in said final step of said forming.

15. The apparatus according to claim 14, wherein said further seat is obtained in a first annular circumferal section of said abutment wall suitable for forming in said casing a corresponding first annular circumferal zone of said edge.

16. The apparatus according to claim 15, wherein said further seat is a continuous annular groove arranged in said first annular section.

17. The apparatus according to claim 15, wherein said first operating device comprises a plurality of grooves arranged in separate portions of said first annular section.

18. The apparatus according to claim 17, wherein said first operating device comprises a plurality of grooves arranged alternatively in separate portions of said first annular circumferal section and of a second annular circumferal section of the abutment wall, arranged externally in said radial direction with respect to said first annular circumferal section.

19. The apparatus according to claim 14, wherein said seat and said further seat comprise respective bottom walls, said bottom wall of said seat being substantially parallel to said bottom wall of said further seat.

20. The apparatus according to claim 14, wherein said plate is provided with a hole to enable said compressed air and said punch to go through said chamber towards said first operating device.

21. The apparatus according claim 14, and further comprising a cutting device for cutting said sheet material outside said first annular section, wherein said cutting device is arranged downstream of said forming arrangement in an advancing direction of the sheet material.

22. The apparatus according to claim 15, and comprising a joining device for joining, in particular by heat-sealing, after filling said cavity of said capsule of an initial product, a covering element to said edge of said casing at least along a first annular joining portion and a second annular joining portion respectively inside and outside said first annular zone in a radial direction so as to complete said capsule and so as to close hermetically said cavity containing said initial product and said further cavity, in particular containing a fluid like air or inert gas, to make an air cushion between said edge and said covering element that is suitable for defining a sealing element in said capsule arranged for being deformed and sealingly engaging, when compressed, with an abutting element of a dispensing machine.

23. A forming method for making a casing of a capsule by forming a thermoformable plastic material, comprising supporting said sheet material by first operating devide, providing a seat that is suitable for shaping a base wall and a side wall of said casing and providing a space in said first operating device communicating with a mouth of said seat and having, in a plan view, greater overall dimensions than said seat; providing a further space in second operating device and defining a chamber between said space and said further space bounding a portion to be formed of said sheet material, locking said sheet material in at least a first forming operating step wherein a punch of said second operating device intercepts said portion to be formed, pushing the portion towards said seat; further supplying compressed air in a final step of said forming to press said sheet material against said seat and against an abutment wall of said space surrounding said seat to form an edge of said casing extending from said side wall; wherein it further provides at least a further seat communicating with said space arranged outwardly said seat in a radial direction to form in said final step of said forming a further cavity in said edge of said casing by pressing with said compressed air said sheet material against said further seat.
